(19) United States
(12) Patent Application Publication
(10) Pub. No.: US 2015/0015803 A1
(43) Pub. Date: Jan. 15, 2015

(54) Capacitive Touch Screen and Method for Fabricating the Same

(71) Applicants: Chengdu BOE Optoelectronics Technology Co., Ltd., Chengdu, Sichuan (CN); BOE Technology Group Co., Ltd., Beijing (CN)

(72) Inventors: Jing Wang, Beijing (CN); Youqiang Lu, Beijing (CN)

(21) Appl. No.: 14/235,938

(22) PCT Filed: Oct. 12, 2013
(86) PCT No.: PCT/CN2013/085140

§ 371 Date: Jan. 29, 2014

(30) Foreign Application Priority Data
Jun. 25, 2013 (CN) 201310257554.5

(51) Int. Cl. G06F 3/044; G02F 1/1335; G02F 1/1333; G02F 1/1343

(52) U.S. Cl. CPC G06F 3/044; G02F 1/13439; G02F 1/134336; G02F 1/133514; G02F 1/133345
USPC 349/12; 29/622

(57) ABSTRACT

A capacitive touch screen and a method for fabricating the same. The capacitive touch screen includes a substrate and a sensor electrode thereon, the sensor electrode includes first electrode groups which are arranged in the row direction and parallel to each other, second electrode groups which are arranged in the column direction and parallel to each other; the first electrode group includes first type of electrodes which are sequentially electrically connected, the second electrode group includes second type of electrodes which are sequentially electrically connected, each of at least one type of electrodes of the first type of electrodes and the second type of electrodes includes a peripheral electrode arranged in the periphery and a central electrode electrically isolated from the peripheral electrode, and peripheral electrodes of two adjacent electrodes of the electrode group including the at least one type of electrodes are electrically connected to each other.

### TECHNICAL FIELD

The present invention belongs to the field of display technology, and relates to a capacitive touch screen and a method for fabricating the capacitive touch screen.

### BACKGROUND

A touch screen is the latest information input device, and it enables simple, easy and natural human-computer interaction, providing people with a new multimedia human-computer interaction way. Because it has advantages of sensitive touch response, supporting multi-point touching, etc., people's visual and tactile pleasure is greatly met.

According to working principles and transmission media, the touch screens can be classified into resistive, capacitive, surface acoustic wave and infrared type touch screens, and the capacitive touch screen is widely used due to its high accuracy and strong anti-interference ability.

Meanwhile, in order to implement a thin and light touch screen, methods for integrating a liquid crystal panel with a touch panel function occur, specifically including “In-cell” method and “On-cell” method. The “In-cell” method is a method for embedding a touch panel into the pixel region, and the “On-cell” method is a method for embedding the touch panel between the color film substrate and the polarizer plate. Due to limitations of the current semiconductor manufacturing process, it is difficult to embed the touch sensor into the pixel region on the array substrate in the “In-cell” method and to solve the problem that the effective display area is reduced after the touch sensors are embedded into the pixel region, which make it difficult to ensure yield and display performance, and therefore the “In-cell” method has not been practically used. As for the “On-cell” method, since the procedure for forming a simple sensor electrode pattern between the color filter substrate, and a polarizing plate has been relatively mature, and the problem that the effective display area within the pixel region is reduced will not be caused so that yield and display performance can be easily ensured, it has been widely used.

Depending on various driving fields, TFT liquid crystal displays (TFT-LCDs) can be classified into two types, that is horizontal electric filed type TFT-LCDs and vertical electric field type TFT-LCDs. The vertical electric field type TFT-LCDs mainly include two types, i.e., a Vertical Alignment (abbreviated as VA) type, and a Twisted Nematic (abbreviated as TN) type. FIG. 1 shows a structural diagram of a vertical electric field type liquid crystal display comprising a color filter substrate 1 (CF), an array substrate 2 (TFT) and a liquid crystal layer 3 between the color filter substrate 1 and the array substrate 2. A common electrode 11 (COM ITO) is arranged on a side of the color filter substrate 1 close to the liquid crystal layer 3, a pixel electrode 21 (PXL ITO) is arranged on the array substrate 2, and the common electrode 11 and the pixel electrode 21 form a vertical electric field to drive liquid crystal molecules in the liquid crystal layer 3 to display an image.

In the “On-cell” capacitive touch screen for a vertical electric field type liquid crystal display, a transparent sensor (Sensor) electrode is also provided on the color film substrate, and the touch sensitive function is realized by the sensor electrode. As shown in FIGS. 2 and 3, the sensor electrode 4 includes a plurality of first electrode groups 41 which are arranged in the row direction and parallel to each other, and arranged at intervals, and a plurality of second electrode groups 42 which are arranged in the column direction and parallel to each other, and arranged at intervals. The first electrode group 41 and the second electrode group 42 respectively include rhombus-shaped electrodes which are electrically connected in series sequentially. Each rhombus-shaped electrode of the first electrode group 41 is oriented transversely (i.e., in the left-right direction or the horizontal direction in FIG. 2), each rhombus-shaped electrode of the second electrode group 42 is oriented longitudinally (i.e., in the up-down direction or the vertical direction in FIG. 2), an electrical connection part between two adjacent first electrodes of the first electrode group 41 and a corresponding electrical connection part between two adjacent second electrodes of the second electrode group 42 are insulated from each other by an insulating layer 6, are partially overlapped in the orthogonal projection direction, and a node capacitor is formed at the overlapping region.

As for structure of the above “On-cell” capacitive touch screen for the vertical electric field type liquid crystal display, in the fabricating process, two metal layers are first sequentially deposited on the color filter substrate 1, wherein one metal layer is used to form the sensor electrode 4 and a bridging part for electrically connecting electrode groups in the row/column, and the other metal layer is used to form a bridging part for electrically connecting electrode groups in the column/row. As shown in FIGS. 3 and 4, electrodes of the second electrode group 42 are electrically connected to a second type of conducting parts 425 through a plurality of relatively small via holes 426 provided in the insulating layer 6 so that the electrical connection is achieved by the second type of conducting parts 425.

It has been proved by test that in the vertical electric field type liquid crystal display, directly fabricating a conventional touch sensor panel (abbreviated as TSP), will result in very large coupling between the sensor electrode and the common electrode in the liquid crystal display, that is, the entire effective area of a single sensor electrode is to be area of one plate of the capacitor, leading too heavy RC loading, and further leading the defect that the sensor electrode may be insufficiently charged when sampling, and affecting touch sensitivity of the touch screen.

### SUMMARY OF THE INVENTION

In order to solve the above technical problem, the present invention provides a capacitive touch screen and a method for fabricating the same, and in the capacitive touch screen, coupling between the sensor electrode and the common electrode is small and the RC loading is reduced so that the sensor electrode is charged faster to ensure high touch sensitivity of the capacitive touch screen.

The technical problem of the invention is to be solved by providing a capacitive touch screen which includes a substrate and a sensor electrode disposed on the substrate, the sensor electrode includes a plurality of first electrode groups which are arranged in the row direction and parallel to each other, and a plurality of second electrode groups which are arranged in the column direction and parallel to each other; and the first electrode group includes a plurality of first type of electrodes which are sequentially electrically connected and the second electrode group includes a plurality of second type of electrodes which are sequentially electrically connected, wherein, each of at least one type of electrodes of the first type of electrodes and the second type of electrodes includes a peripheral electrode arranged in the periphery and a central electrode electrically isolated from the peripheral electrode, and peripheral electrodes of two adjacent electrodes of the electrode group including, the at least one type of electrodes are electrically connected to each other.

Preferably, each of the at least one type of electrodes is provided with a closed isolating trench, the central electrode is arranged at the inner side of the isolating trench, the peripheral electrode is arranged at the outer side of the isolating trench, and the peripheral electrode and the central electrode are isolated from each other by the isolating trench.

Preferably, the shape of the isolating trench is substantially the same as the contour shape of the electrode in which the isolating trench is located, and the depth of the isolating trench is equal to the thickness of the electrode.

Preferably, the first type of electrodes and the second type of electrodes are rhombus-shaped and are of the same size, the isolating trench is rhombus-shaped, and the width of the isolating, trench is in the range of 5 μm to 30 μm.

Preferably, the area of each central electrode is 30% to 70% that of the electrode including the central electrode.

Preferably, a first type of conducting part is provided between rhombus corners of every two adjacent first type of electrodes along the direction the first electrode groups are arranged, and the two adjacent first type of electrodes are electrically connected to each other by the first type of conducting part; a second type of conducting part is provided between rhombus corners of every two adjacent second type of electrodes along the direction the second electrode groups are arranged, and the two adjacent second type of electrodes are electrically connected to each other by the second type of conducting part; the first type of conducting part and the second type of conducting part are provided in different layers and are partially overlapped in the orthogonal projection direction.

Preferably, an insulating layer is provided between the first type of conducting parts and the second type of conducting parts, one type of conducting parts of the first type of conducting parts and the second type of conducting parts are formed in the same layer as the first type of electrodes and the second type of electrodes, the other type of conducting parts of the first type of conducting parts and the second type of conducting parts are provided under the one type of conducting parts, the insulating layer is provided with via holes, and the other type of conducting parts and its corresponding electrodes are electrically connected to each other through the via holes respectively.

Preferably, each of the first type of conducting parts is strip-shaped, the width of each of the first type of conducting parts is smaller than a space between two adjacent second type of electrodes along the direction the second electrode groups are arranged, and the length of each of the first type of conducting parts is equal to or larger than a space between two adjacent first type of electrodes along the direction the first electrode groups are arranged; and each of the second type of conducting parts is strip-shaped, the width of each of the second type of conducting parts is smaller than the space between two adjacent first type of electrodes along the direction the first electrode groups are arranged, and the length of each of the second type of conducting parts is equal to or larger than the space between two adjacent second type of electrodes along the second electrode groups are arranged.

Preferably, the first type of electrodes, the second type of electrodes and the one type of conducting parts which are provided in the same layer as the first and second type of electrodes are formed of Indium Tin Oxide; and the other type of conducting parts which are provided in a layer different from that the first and second type of electrodes are provided in are formed of at least one from molybdenum, molybdenum-niobium alloy, aluminum, aluminum-neodymium alloy, titanium, and copper.

Preferably, a color filter layer is further provided on a surface of the substrate opposite to the first and second electrode groups.

The present invention further provides a method for fabricating a capacitive touch screen including a step of forming a sensor electrode on a substrate, the sensor electrode includes a plurality of first electrode groups which are arranged in the row direction and parallel to each other, and a plurality of second electrode groups which are arranged in the column direction and parallel to each other; and the first electrode group includes a plurality of first type of electrodes which are sequentially electrically connected and the second electrode group includes a plurality of second type of electrodes which are sequentially electrically connected, wherein, each of at least one type of electrodes of the first type of electrodes and the second type of electrodes includes a peripheral electrode arranged in the periphery and a central electrode electrically isolated from the peripheral electrode, and peripheral electrodes of two adjacent electrodes of the electrode group including the at least one type of electrodes are electrically connected to each other.

Preferably, the step of forming the sensor electrode on the substrate particularly includes:

Step S11: forming a pattern including one type of conducting parts of first type of conducting parts and second type of conducting parts on the substrate; Step S12: forming an insulating layer on the substrate subjected to Step S11 such that the insulating layer is provided with via holes at regions corresponding to ends of the one type of conducting parts; Step S13: forming patterns including the first type of electrodes, the second type of electrodes and the other type of conducting parts of the first type of conducting parts and the second type of conducting parts on the substrate subjected to Step S12 such that a pattern including a dosed isolating trench is also formed in each of the at least one type of electrodes, and the central electrode and the peripheral electrode are electrically isolated from each other by the isolating trench; and Step S14: forming a passivation layer on the substrate subjected to Step S13, wherein, when the one type of conducting parts are the first type of conducting parts, adjacent first electrodes are electrically connected to one of the first type of conducting parts through the via holes so as to be electrically connected to each other through one of first type of conducting parts, and adjacent second type of electrodes are electrically connected to each other through one of the second type of conducting parts; and when the one type of conducting parts are the second type of conducting parts, adjacent first type of electrodes are electrically connected to each other through one of the first type of conducting parts, and adjacent second type of electrodes are electrically connected to one of second type of conducting parts through the via holes so as to be electrically connected to each other through one of second type of conducting parts.

Preferably, in Step S13, forming the patterns including the first type of electrodes, the second type of electrodes and the other type of conducting parts which are provided in the same layer using one patterning process, the other type of conducting parts and the one type of conducting parts formed in Step S11 are partially overlapped in the orthogonal projection direction.

Preferably, the shape of the isolating trench is substantially the same as the contour shape of the electrode in which the isolating trench is located, and the depth of the isolating trench is equal to the thickness of the electrode.

Preferably, the first type of electrodes and the second type of electrodes are rhombus-shaped and are of the same size, the isolating trench is rhombus-shaped, and the width of the isolating trench is in the range of 5 μm to 30 μm.

Preferably, the area of each the central electrode is 30% to 70% that of the electrode including the central electrode.

Preferably, each of the first type of conducting parts is strip-shaped, each of the first type of conducting parts is formed between rhombus corners of two adjacent first type of electrodes along the direction the first electrode groups are arranged respectively, the width of each of die first type of conducting parts is smaller than a space between two adjacent second type of electrodes along the direction the second electrode groups are arranged, and the length of each of the first type of conducting parts is equal to or larger than a space between two adjacent first type of electrodes along the direction the first electrode groups are arranged; and each of the second type of conducting parts is strip-shaped, each of the second type of conducting parts is formed between rhombus corners of two adjacent second type of electrodes along the direction the second electrode groups are arranged respectively, the width of each of the second type of conducting parts is smaller than the space between two adjacent first type of electrodes along the direction the first electrode groups are arranged, and the length of each of the second type of conducting parts is equal to or larger than the space between two adjacent second type of electrodes along the second electrode groups are arranged.

Preferably, the first type of electrodes, the second type of electrodes and the other type of conducting parts which are provided in the same layer as the first and second type of electrodes are formed of Indium Tin Oxide; and the one type of conducting parts which are provided in a layer different from that the first and second type of electrodes are provided in are formed of at least one from molybdenum, molybdenum-niobium alloy, aluminum, aluminum-neodymium alloy, titanium, and copper.

Preferably, after completing the step of forming the at least one type of electrodes such that each includes a peripheral electrode arranged in the periphery and a central electrode electrically isolated from the peripheral electrode and peripheral electrodes of two adjacent electrodes of the electrode group including the at least one type of electrodes are electrically connected to each other, the method further includes:

Step S21: inverting the substrate in the vertical direction; and

Step S22: forming a color filter film on the surface of the inverted substrate opposite to the first electrode group and the second electrode group.

Advantageous effects of the present invention are as follows: in the “On-cell” capacitive touch screen for the vertical electric field type liquid crystal display of the present invention, since a floating central electrodes are used in the sensor electrode, coupling between the sensor electrode and the common electrode becomes small, so that the RC loading is reduced, the sensor electrode is charged faster, anti-interference ability is greater, and touch sensitivity is higher, making the display device have higher display quality as well as a good touch effect.

### BRIEF DESCRIPTION OF DRAWINGS

FIG. 1 is a structural diagram of a vertical electric field type liquid crystal display in the prior art;

FIG. 2 is a top view of a sensor electrode of the capacitive touch screen for the vertical electric field type liquid crystal display of FIG. 1 in the prior art;

FIG. 3 is a partially enlarged top view of the sensor electrode of the capacitive touch screen in FIG. 2;

FIG. 4 is a partially enlarged top view illustrating a bridging in the capacitive touch screen in FIG. 2;

FIG. 5 is a structural diagram of a vertical electric field type liquid crystal display in Embodiment 1 of the present invention;

FIG. 6 is a top view of the sensor electrode of the capacitive touch screen in FIG. 5;

FIG. 7 is a partially enlarged top view of the sensor electrode of the capacitive touch screen in FIG. 6;

FIG. 8 is a partially enlarged top view illustrating a bridging in the capacitive touch screen in FIG. 6;

FIG. 9 is a cross-sectional view of section A-A in FIG. 8;

FIG. 10 is a cross-sectional view of section B-B in FIG. 8; and

FIGS. 11A-11F are cross-sectional views illustrating respective fabrication steps of the capacitive touch screen in FIG. 5.

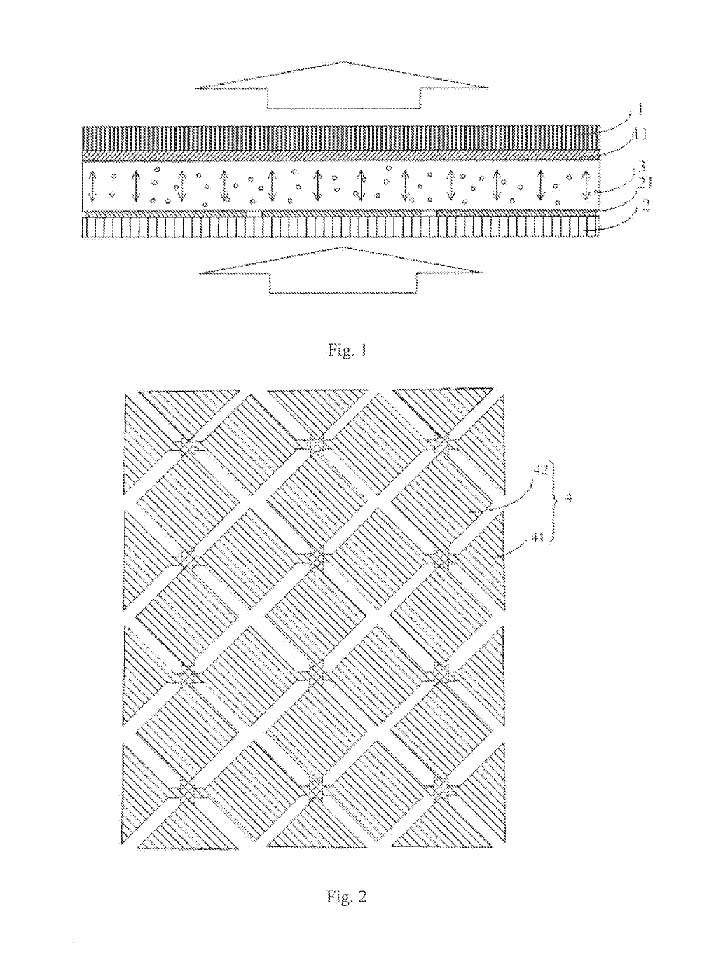

In the Figures:

1—color filter substrate; 11—common electrode; 12—color filter layer; 2—array substrate; 21—pixel electrode; 3—liquid crystal layer; 4—sensor electrode; 41—first electrode group; 411—first electrode; 412—first isolating trench; 413—first central electrode; 414—first peripheral electrode; 415—first type of conducting part; 42—second electrode group; 421—second type of electrode; 422—second isolating trench; 423—second central electrode; 424—second peripheral electrode; 425—second type of conducting part; 426—via hole; 5—substrate; 6—insulating layer; 7—passivation layer.

### DETAILED DESCRIPTION OF EMBODIMENTS

In order to make persons skilled in the art better understand the technical solutions of the present invention, the capacitive touch screen and a method for fabricating the capacitive touch screen of the present invention will be further described in detail in conjunction with the accompanying drawings and specific embodiments.

A capacitive touch screen includes a substrate and a sensor electrode disposed on the substrate, the sensor electrode includes a plurality of first electrode groups which are arranged in the row direction and parallel to each other, and a plurality of second electrode groups which are arranged in the column direction and parallel to each other; and the first electrode group includes a plurality of first type of electrodes which are sequentially electrically connected and the second electrode group includes a plurality of second type of electrodes which are sequentially electrically connected, wherein, each of at least one type of electrodes of the first type of electrodes and the second type of electrodes includes a peripheral electrode arranged in the periphery and a central electrode electrically isolated from the peripheral electrode, and peripheral electrodes of two adjacent electrodes of the electrode group including the at least one type of electrodes are electrically connected to each other.

A method for fabricating a capacitive touch screen includes a step of forming a sensor electrode on a substrate, the sensor electrode includes a plurality of first electrode groups which are arranged in the row direction and parallel to each other, and a plurality of second electrode groups which are arranged in the column direction and parallel to each other; and the first electrode group includes a plurality of first type of electrodes which are sequentially electrically connected and the second electrode group includes a plurality of second type of electrodes which are sequentially electrically connected, wherein, each of at least one type of electrodes of the first type of electrodes and the second type of electrodes includes a peripheral electrode arranged in the periphery and a central electrode electrically isolated from the peripheral electrode, and peripheral electrodes of two adjacent electrodes of the electrode group including the at least one type of electrodes are electrically connected to each other.

### Embodiment 1

As shown in FIGS. 5 to 7, the capacitive touch screen includes a substrate and a sensor electrode 4 disposed on the substrate, the sensor electrode 4 includes a plurality of first electrode groups 41 which are arranged in the row direction and parallel to each other, and a plurality of second electrode groups 42 which are arranged in the column direction and parallel, to each other; and the first electrode group 41 includes a plurality of first type of electrodes 411 which are sequentially electrically connected and the second electrode group 42 includes a plurality of second type of electrodes 421 which are sequentially electrically connected. In the present embodiment, each of the first type of electrode 411 and the second type of electrode 412 includes a peripheral electrode arranged in the periphery and a central electrode electrically isolated from the peripheral electrode, and adjacent peripheral electrodes in the same row or column are electrically connected to each other.

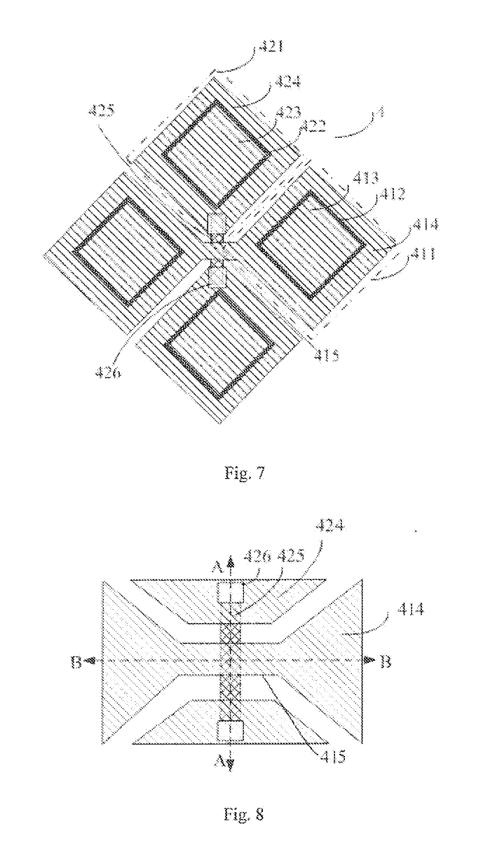

As shown in FIG. 7, the first type of electrode 411 is provided with a closed first isolating trench 412, a first central electrode 413 is provided at the inner side of the first isolating trench 412, a first peripheral electrode 414 is provided at the outer side of the first isolating trench 412, the first central electrode 413 and the first peripheral electrode 414 are electrically isolated from each other through the first isolating trench 412, and adjacent first periphery electrodes 414 are electrically connected to each other; at the same time, the second type of electrode 421 is provided with a closed second isolating trench 422, a second central electrode 423 is provided at the inner side of the second isolating trench 422, a second peripheral electrode 424 is provided at the outer side of the second isolating trench 422, the second central electrode 423 and the second peripheral electrode 424 are electrically isolated from each other through the second isolating trench 422 and adjacent second peripheral electrodes 424 are electrically connected to each other.

In order to make the peripheral electrode completely electrically isolated from the central electrode, preferably, the shape of the first isolating trench 412 is substantially the same as the contour shape of the first type of electrode 411, and the depth of the first isolating trench 412 is equal to the thickness of the first type of electrode 411; the shape of the second isolating trench 422 is substantially the same as the contour shape of the second type of electrode 421, and the depth of the second isolating trench 422 is equal to the thickness of the second type of electrode 421.

In the present embodiment, the first type of electrode 411 and the second type of electrode 421 are rhombus-shaped and are of the same size, the first isolating trench 412 is rhombus-shaped, and the width of the first isolating trench 412 is in the range of 5 μm to 30 μm; the second isolating trench 422 is rhombus-shaped, and the width of the second isolating trench 422 is in the range of 5 μm to 30 μm. The isolating trench within such a width range not only can electrically isolate the central electrode from the peripheral electrode effectively, but also will not affect visual effects of the touch screen.

Preferably, the area of the first central electrode 413 is 30% to 70% that of the first type of electrode 411, if it is less than 30%, coupling between the sensor electrode and the liquid crystal display becomes large, which will affect charging efficiency; and if it is larger than 70%, the effective touch region becomes small, which will affect change of amount of touch signals; for example, when the outer side length of the rhombus of the first peripheral electrode 414 is 5 mm, the side length of the rhombus of the first central electrode 413 is in the range of 2.7 μm to 4.2 mm; the area of the second central electrode 423 is 30% to 70% that of the second type of electrode 421, if it is less than 30%, coupling between the sensor electrode and the liquid crystal display becomes large, which will affect charging efficiency; and if it is larger than 70%, the effective touch region becomes small, which will affect change of amount of touch signals. With area ratio in the above range, coupling between the sensor electrode 4 and the common electrode can be reduced effectively to decrease RC loading effectively, and touch sensitivity of the touch screen will not be affected.

As shown in FIGS. 7 and 8, in order to ensure electrical connection between respective first type of electrodes 411 in the first electrode group 41, a first type of conducting part 415 is provided between rhombus corners of two adjacent first peripheral electrodes 414 along the direction the first electrode group 41 is arranged, and the two adjacent first peripheral electrodes 414 are electrically connected to each other by the first type of conducting part 415; accordingly, in order to ensure electrical connection between respective second type of electrodes 421 in the second electrode group 42, a second type of conducting part 425 is provided between rhombus corners of two adjacent second peripheral electrodes 424 along the direction the second electrode group 42 is arranged, and the two adjacent second peripheral electrodes 424 are electrically connected to each other by the second type of conducting part 425, the first type of conducting part 415 and the second type of conducting part 425 are provided in different layers and partially overlapped in the orthogonal projection direction.

As shown in FIG. 5, and also referring to FIG. 7, an insulating layer 6 is provided between the first type of conducting part 415 and the second type of conducting part 425. In the present embodiment, the first type of conducting part 415 is provided in the same layer as the first type of electrode 411 and the second type of electrode 421 are formed, the second type of conducting part 425 is provided under the first type of conducting part 415, a via hole 426 is provided in the insulating layer 6, and the second type of conducting part 425 and the second type of electrode 421 are electrically connected to each other through the via hole 426.

Preferably, the insulating layer 6 is formed of at least one material from silicon oxide, silicon nitride, hafnium oxide, silicon nitride oxide, aluminum oxide.

Herein, it should be understood that in order to more clearly illustrate position relationship between the first type of conducting part 415 and the second type of conducting part 425 in the present embodiment, the first type of conducting part 415, the first peripheral electrode 414 and the second peripheral electrode 424 in FIG. 8 are drawn to have a certain transparency; in order to more clearly illustrate the electrical connection structure of the second type of conducting part 425 and the second type of electrode 421 in the present embodiment, the via hole 426 is drawn to have a certain transparency; at the same time, it should be understood that, since the insulating layer 6 is typically formed of transparent material (silicon oxide, silicon nitride, hafnium oxide, silicon nitride oxide, aluminum oxide), which will not block observation for the plan view, illustration of the insulating layer 6 in the top view of FIG. 7 is omitted so as to better illustrate relative position relationship between the second type of conducting part 425 and the second type of electrode 421.

The first type of conducting part 415 is strip-shaped, the width of the first type of conducting part 415 is less than the space between two adjacent second type of electrodes 421 along the direction the second electrode group 42 is arranged, the length of the first type of conducting part 415 is equal to or larger than the space between two adjacent first type of electrodes 411 along the direction the first electrode group 41 is arranged; the second type of conducting part 425 is strip-shaped, the width of the second type of conducting part 425 is less than the space between two adjacent first type of electrodes 411 along the direction the second electrode group 41 is arranged, the length of the second type of conducting part 425 is equal to or larger than the space between two adjacent second type of electrodes 421 along the direction the second electrode group 42 is arranged.

In the present embodiment, preferably, the first type of electrode 411, the second type of electrode 412, and the first type of conducting part 415 which is provided in the same layer as the first type of electrode 411 and the second type of electrode 412 are formed of Indium Tin Oxide (abbreviated as ITO). Since ITO is transparent, the resulting sensor electrode 4 will not block display function of the touch screen while ensuring the touch function. Of course, the present invention is not limited to forming the sensor electrode with ITO, transparent material can be used to form the sensor electrode, as long as the transparent material is conductive and can be processed through semiconductor fabrication processes, and the material is not limited in the present invention.

Preferably, the second type of conducting part 425, which is provided in a layer different from that the first type of electrode 411 and the second type of electrode 412 are provided in, is formed of at least one from molybdenum, molybdenum-niobium alloy, aluminum, aluminum-neodymium alloy, titanium, and copper. All the above materials are conductive and have smaller resistance than ITO so as to ensure good electrical connection between the second type of electrodes 421.

Of course, as the “On-cell” capacitive touch screen or the vertical electric field type liquid crystal display, in the capacitive touch screen of the embodiment, a color filter layer 12 is provided on one surface of the substrate opposite to the first electrode group 41 and the second electrode group 42, that is, the capacitive touch screen includes the color filter substrate 1 and the array substrate 2 in FIG. 5. Structures of the color filter substrate 1 and the array substrate 2 are the same as those in the prior art and the description thereof is omitted herein.

Accordingly, the present embodiment further provides a method for fabricating a capacitive touch screen including a step of forming a sensor electrode on a substrate, the sensor electrode includes a plurality of first electrode groups which are arranged in the row direction and parallel to each other, and a plurality of second electrode groups which are arranged in the column direction and parallel to each other and the first electrode group includes a plurality of first type of electrodes which are sequentially electrically connected and the second electrode group includes a plurality of second electrodes which are sequentially electrically connected, wherein, each of the first type of electrode and the second type of electrode is formed to include a peripheral electrode arranged in the periphery and a central electrode electrically isolated from the peripheral electrode and adjacent peripheral electrodes in the same row or column are electrically connected to each other.

Before describing the method for fabricating the capacitive touch screen in the present embodiment in detail, the following is first defined: in the present invention, the patterning process may include only a photolithography process, or include a photolithography process and an etching step, at the same time may also include printing, inkjet and other processes for forming a predetermined pattern; the photolithography process refers to a process of forming a pattern using photoresist, a mask plate, an exposure machine etc., which includes film formation, exposure, development and other steps. A corresponding patterning process may be selected according to the structure formed in the present invention.

In particular, the step of forming the sensor electrode on the substrate includes the following steps.

Step S11: on the substrate, forming a pattern including the second type of conducting part.

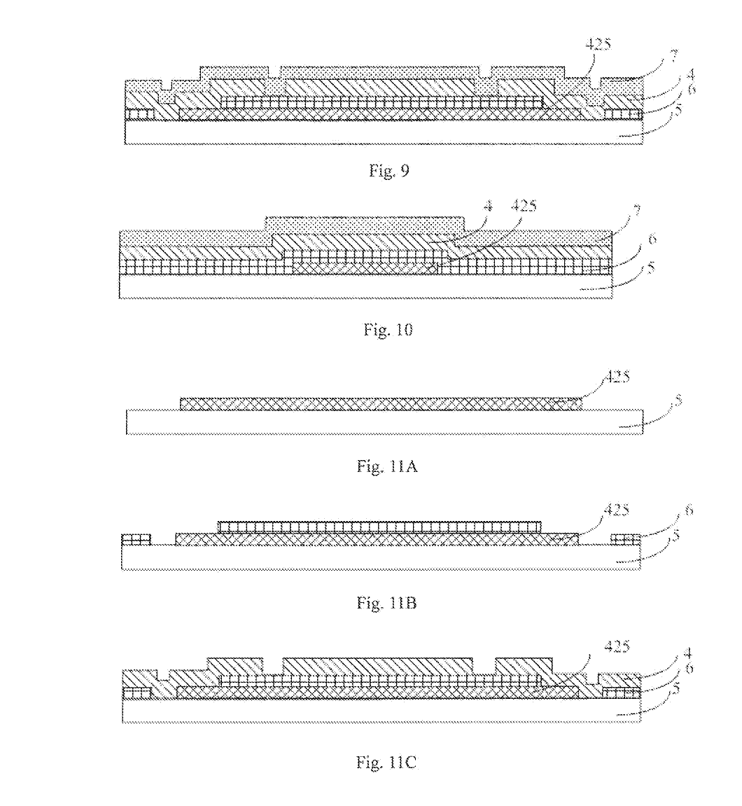

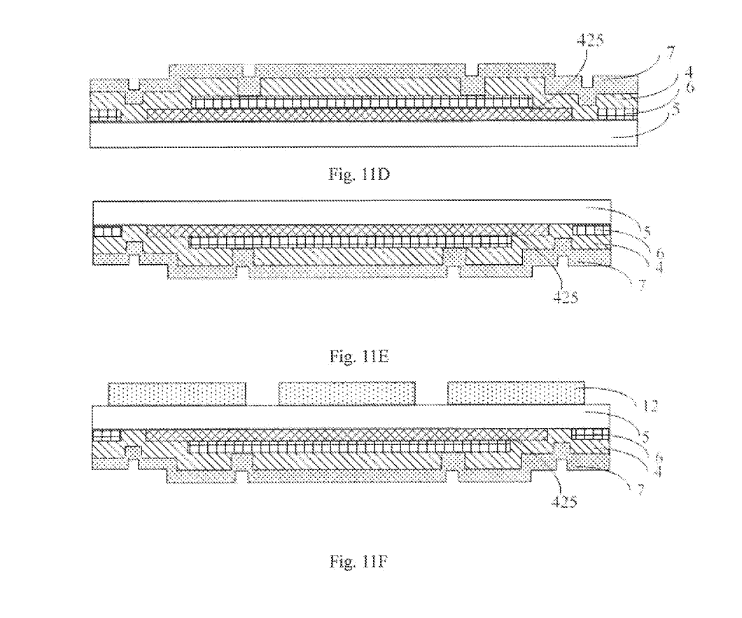

A shown in FIG. 11A, in this step, a layer of thin metal film is first formed on the substrate 5 using methods such as deposition, sputtering and thermal evaporation. The layer of thin metal film may be formed of at least one from molybdenum, molybdenum-niobium alloy, aluminum, aluminum-neodymium alloy, titanium, and copper.

Then, by patterning processes such as exposure, development, etching etc., the layer of thin metal film is processed to form a pattern including the second type of conducting part 425.

Step S12: on the substrate subjected to Step S11, forming an insulating layer such that the insulating layer is provided with a via hole at the region corresponding to the end of the second type of conducting part.

As shown in FIG. 11B, in this step, on the substrate subjected to Step S11, a layer of insulating film is formed using plasma enhanced chemical vapor deposition and the insulating layer 6 is then formed by one photolithography process with an ordinary mask plate. The insulating layer 6 is formed of at least one material from silicon oxide, silicon nitride, hafnium oxide, silicon nitride oxide, aluminum oxide.

Step S13: on the substrate subjected to Step S12, forming a pattern including the first type of electrode, a second type of electrode and the first type of conducting part such that a pattern of a closed first isolating trench is formed in the first type of electrode, a pattern of a closed second isolating trench is formed in the second type of electrode, adjacent first type of electrodes are electrically connected to each other by the first type of conducting part, and adjacent second type of electrodes are electrically connected to the second type of conducting part through the via holes to be electrically connected to each other by the second type of conducting part.

In this step, a layer of thin metal film is formed on the substrate subjected to Step S12 using a process such as deposition, sputtering and thermal evaporation. The layer of thin metal film may be formed of ITO.

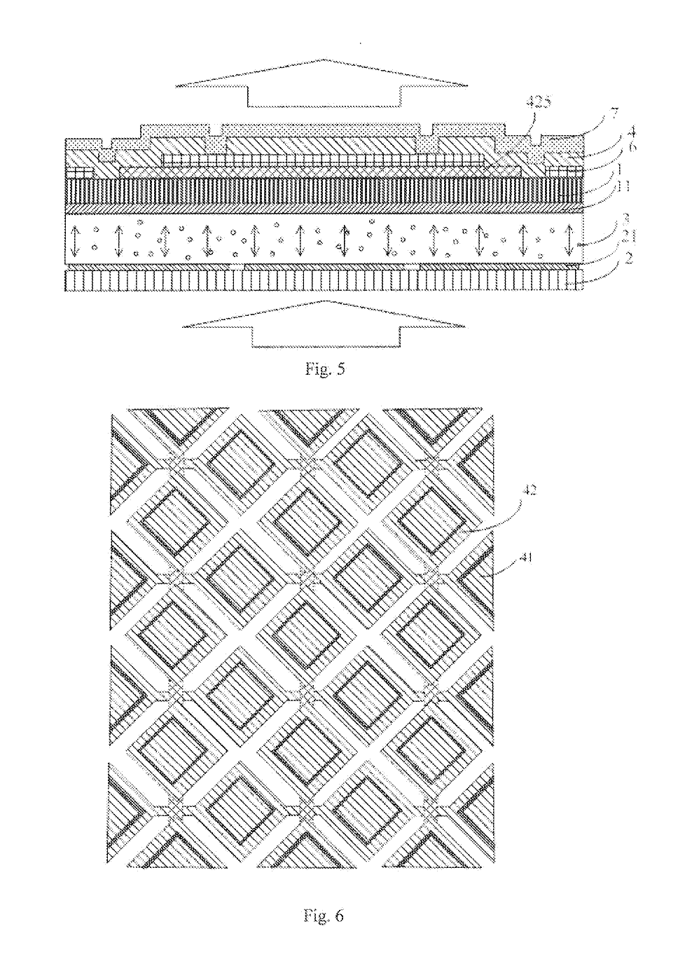

Then, patterning processes such as exposure, development and etching are performed on the layer of thin metal film to form a pattern including the first type of electrode, the second type of electrode and the first type of conducting part. As shown in FIG. 11C and also referring to FIGS. 4 and 7, in this step, one patterning process is used to form a pattern including the first type of electrode 411, the second type of electrode 421 and the first type of conducting part 415 which are provided in the same layer (the particular position relationship among the first type of electrode 411, the second type of electrode 421 and the first type of conducting part 415 is shown in FIGS. 6 and 7), and the first type of conducting part 415 and the second type of conducting part 425 formed in Step S11 are partially overlapped in the orthogonal direction.

Referring to FIG. 7, the shape of the first isolating trench 412 is substantially the same as the contour shape of the first type of electrode 411, and the depth of the first isolating trench 412 is equal to the thickness of the first type of electrode 411; the shape of the second isolating trench 422 is substantially the same as the contour shape of the second type of electrode 421, and the depth of the second isolating trench 422 is equal to the thickness of the second type of electrode 421.

Preferably, both the first type of electrode 411 and the second type of electrode 421 are rhombus-shaped and are of the same size, the first isolating trench 412 is rhombus-shaped, and the width of the first isolating trench 412 is in the range of 5 μm to 30 μm; the second isolating trench 422 is rhombus-shaped and the width of the second isolating trench 422 is in the range of 5 μm to 30 μm.

Preferably, the area of the first central electrode 413 is 30% to 70% that of the area of the first type of electrode 411, and the area of the second central electrode 423 is 30% to 70% that of the area of the second type of electrode 421.

In this step, the mask plate used in the exposure process has patterns for correspondingly forming the first isolating trench 412 and the second isolating trench 422, in addition to patterns for correspondingly forming the first type of electrode 411 and the second type of electrode 421. Patterns for correspondingly forming the first isolating trench 412 and the second isolating trench 422 correspond to regions in which photoresist will be completely removed, and accordingly, after the exposure process and the development process are completed, corresponding portions in the layer of thin metal film are completely removed in the etching process to form the first isolating trench 412 and the second isolating trench 422.

In the present embodiment, as shown in FIG. 7, the first central electrode 413 and the first peripheral electrode 414 are completely electrically isolated from each other (that is, there is not any signal transmission therebetween, and the first central electrode is equivalent to be in a floating state), and the second central electrode 423 and the second peripheral electrode 424 are completely electrically isolated from each other (that is, that is, there is not any signal transmission therebetween, and the second central electrode is equivalent to be in a floating state). Compared with the sensor electrode in the capacitive touch screen in the prior art, the first central electrode 413 and the second central electrode 423 are floating ITO islands, so the first central electrode 413 and the second central electrode 423 will not generate coupling with the common electrode when the sensor electrode 4 is being charged, so as to avoid generation of RC loading.

Herein, it should be understood that, the pattern of the sensor electrode 4 in the present invention is not limited to the rhombus-shaped pattern illustrated in the present embodiment, and essence of the present invention is to reduce coupling between the sensor electrode and the common electrode with the design of the floating central electrode, and changes of the sensor electrode 4 in the outer shape or the related structure can be made without departing from the protection scope of the present invention.

In the present embodiment, the first type of conducting part 415 is strip-shaped, the first type of conducting part 415 is formed between rhombus corners of two adjacent first peripheral electrodes 414 along the direction the first electrode group 41 is arranged, the width of the first type of conducting part 415 is smaller than a space between two adjacent second type of electrodes 421 along the direction the second electrode group 42 is arranged, and the length of the first type of conducting part 415 is equal to or larger than a space between two adjacent first type of electrodes 411 along the direction the first electrode group 41 is arranged; the second type of conducting part 425 is strip-shaped, the second type of conducting part 425 is formed between rhombus corners of two adjacent second peripheral electrodes 424 along the direction the second electrode group 42 is arranged, the width of the second type of conducting part 425 is smaller than the space between two adjacent first type of electrodes 411 along the direction the first electrode group 41 is arranged, and the length of the second type of conducting part 425 is equal to or larger than the space between two adjacent second type of electrodes 421 along the second electrode group 42 is arranged.

In the present embodiment, bridgings and edge wirings between the second type of electrodes 421 are formed from the layer of thin metal film in Step S11, wherein, the bridging is the second type of conducting part 425, and the edge wiring is electrically connecting wires between the sensor electrode and the peripheral circuit of the capacitive touch screen; bridgings (i.e. the first type of conducting parts 415) between the first type of electrodes 411 are formed from the layer of thin metal film in Step S13.

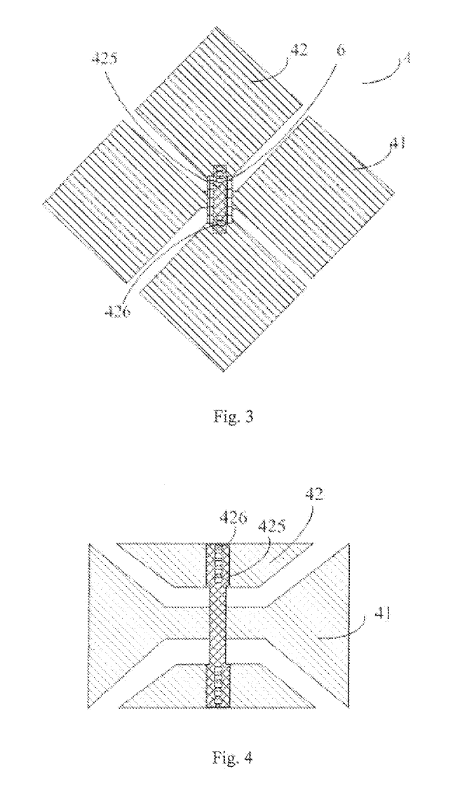

As shown in FIGS. 7 and 8, compared with the method for electrically connecting the sensor electrodes in the prior art, it is only necessary to form a relatively large via hole 426 in the insulating layer 6 in the present embodiment, which simplifies the process design and reduces the process error; at the same time, electric connection between the second type of electrode and the second type of conducting part provided in different layers is achieved by the relatively large via hole, and compared with the conventional method in which a plurality of relatively small via holes are used to achieve electric connection between the electrode and the conducting part provided in different layers (as shown in FIGS. 3 and 4), stable electric connection is more easily obtained so that the display screen is more clean and a better blanking effect can be achieved. The same as in the prior art, in the present embodiment, touch sense is still achieved by mutual induction between the first electrode group 41 and the second electrode group 42, which will not affect coupling between Tx (Transmit) and Rx (Receive) in the coupling electric field, and the sensitivity is enhanced.

FIGS. 9 and 10 illustrate cross-sectional views of the capacitive touch screen taken along the horizontal direction (A-A) and the vertical direction (B-B) in the present embodiment. FIG. 9 illustrates that the second type of electrodes 421 of the second electrode group 42 in the column direction are electrically connected to each other by the second type of conducting parts 425 (metal bridging), the second type of conducting part 425 is formed of at least one from molybdenum, molybdenum-niobium alloy, aluminum, aluminum-neodymium alloy, titanium, and copper, and two adjacent second type of electrodes 421 in the second electrode group 42 are electrically connected to each other by the second type of conducting part 425; FIG. 10 illustrates that the first type of electrodes 411 of the first electrode group 41 in the row direction are electrically connected to each other by the first type of conducting parts 415 (the sensor electrode bridgings, in FIG. 10, a portion of the sensor electrode at a region corresponding to the region of the second type of conducting part 425 is the first type of conducting part 415), the first type of conducting part 415 is formed of ITO material, and two adjacent first type of electrodes 411 in the first electrode group 41 are electrically connected to each other by the first type of conducting part 415. The overlapping region of the first type of conducting part 415 and the second type of conducting part 425 forms a node capacitor, and the first type of conducting part 415 and the second type of conducting part 425 are insulated and isolated from each other by the insulating layer 6.

Step S14: on the substrate subjected to Step S13, forming a passivation layer.

As shown in FIG. 11D, in this step, a passivation layer 7 is vformed on the substrate subjected to Step S13 using plasma enhanced chemical vapor deposition. The passivation layer 7 is formed of at least one material from silicon oxide, silicon nitride, hafnium oxide, silicon nitride oxide and aluminum oxide.

Then, through patterning processes such as exposure, development, and etching, via holes are formed in the passivation layer 7, and the sensor electrode 4 and the edge wiring between peripheral circuits of the capacitive touch screen are electrically connected to each other by the via holes.

At this point, the touch panel function part of the capacitive touch screen is formed.

In the present embodiment, after completing the step of forming the first type of electrode and the second type of electrode such that each of the first type of electrode and the second type of electrode includes the peripheral electrode in the periphery and a central electrode electrically isolated from the peripheral electrode and two adjacent peripheral electrodes in the same row or column are electrically connected to each other, the method further includes the following steps:

Step S21: inverting the substrate in the vertical direction by 180°, as shown in FIG. 11E.

Step S22 on the surface of the inverted substrate opposite to the first electrode group and the second electrode group, forming a color filter layer, as shown in FIG. 11F.

That is, in the present embodiment, the preparation of the touch panel function part is first completed, the substrate is then inverted (the surface having the pattern of the sensor electrode 4 faces down), and on the surface having no pattern, the color filter layer 12 and other corresponding film layers of the color filter substrate 1 are formed using photolithography processes. The method for fabricating the color filter substrate in the present embodiment is the same as that in the prior art, and the description thereof is omitted.

In the present embodiment, an array substrate arranged to be opposite to the color filter substrate is also included, the method for fabricating the array substrate in the present embodiment is the same as that in the prior art and the description thereof is omitted.

### Embodiment 2

The present embodiment is different from Embodiment 1 in that; in the structure of the capacitive touch screen in the present embodiment, the second type of conducting parts are formed in the same layer as the first type of electrodes and the second type of electrodes, the first type of conducting parts are disposed under the second type of conducting parts, the insulating layer is provided with via holes, and the first type of conducting parts and the first type of electrodes are electrically connected to each other by the via holes.

In the present embodiment, the first type of electrodes, the second type of electrodes and the second type of conducting parts are formed of ITO; the first type of conducting parts are formed of at least one from molybdenum, molybdenum-niobium alloy, aluminum, aluminum-neodymium alloy, titanium and copper.

Accordingly, the method for fabricating the capacitive touch screen in the present embodiment particularly includes the following steps:

Step S11: on a substrate, forming a pattern including the first type of conducting parts.

Step S12: on the substrate subjected to Step S11, forming an insulating layer such that the insulating layer is provided with via holes at the regions corresponding to ends of the first type of conducting parts.

Step S13: on the substrate subjected to Step S12, forming patterns including the first type of electrodes, the second type of electrodes, and the second type of conducting parts such that a pattern of a closed first isolating trench is also formed in each of the first type of electrodes, a pattern of a closed second isolating trench is also formed in each of the second type of electrodes, two adjacent second type of electrodes are electrically connected to each other by the second type of conducting part, and two adjacent first type of electrodes are both electrically connected to the first type of conducting part through the via holes so that they are electrically connected to each other by the first type of conducting part.

Step S14: on the substrate subjected to Step S13, forming a passivation layer.

Other parts of the capacitive touch screen and other steps of the method for fabricating the captive touch screen in the present embodiment is the same as those in Embodiment 1, and the description thereof is omitted.

### Embodiment 3

The present embodiment is different from Embodiment 1 and Embodiment 2 in that: in the present embodiment, only the first type of electrodes in the first electrode group or only the second type of electrodes in the second electrode group are provided with a closed isolating trench.

Accordingly, when forming the sensor electrode, the mask plate used in the exposure process has a pattern for correspondingly forming the first isolating trench 412 (corresponding to the case in which each of the first type of electrodes is provided with a closed isolating trench), or has a pattern for correspondingly forming the second isolating trench 422 (corresponding to the case in which each of the second type of electrodes is provided with a closed isolating trench), in addition to patterns for correspondingly forming the first type of electrodes 411 and the second type of electrodes 421. The pattern for correspondingly forming the first isolating trench 412 or the second isolating trench 422 corresponds to a region in which photoresist will be completely removed, and accordingly, after the exposure process and the development process are completed, thin metal film in the corresponding portion of the layer of thin metal film forming the first type of electrode 411 or the second type of electrode 421 is completely removed to form the first isolating trench 412 or the second isolating trench 422.

Other parts of the capacitive touch screen and other steps of the method for fabricating the captive touch screen in the present embodiment is the same as those in Embodiment 1 and Embodiment 2, and the description thereof is omitted.

It should be understood that, in the sensor electrodes of Embodiment 1, Embodiment 2 and Embodiment 3 of the present invention, the electrodes arranged in the row direction are defined as the first type of electrodes and the electrodes arranged in the column direction are defined as the second type of electrodes only to facilitate the description. In fact, directions of the first type of electrodes and the second type of electrodes in the sensor electrode are not limited, that is, the electrodes arranged in the row direction may be defined as the second type of electrodes and the electrodes arranged in the column direction may be defined as the first type of electrodes.

In summary, in the “On-cell” capacitive touch screen of the vertical electric field type liquid crystal display of the present invention, since a floating central electrode is used in the sensor electrode, coupling between the sensor electrode and the common electrode becomes small, so that the RC loading is reduced, the sensor electrode is charged faster, anti-interference ability is enhanced, and touch sensitivity is increased, making the display device have higher display quality as well as a good touch effect.

It should be understood that the foregoing embodiments are merely exemplary embodiments to illustrate the principles of the present invention, but the present invention is not limited thereto. Persons skilled in the art can make various changes and modifications without departing from the scope and spirit of the present invention, and such changes and modifications are also considered to be the scope of the present invention.

1. A capacitive touch screen, including a substrate and a sensor electrode disposed on the substrate, the sensor electrode includes a plurality of first electrode groups which are arranged in the row direction and parallel to each other, and a plurality of second electrode groups which are arranged in the column direction and parallel to each other; and the first electrode group includes a plurality of first type of electrodes which are sequentially electrically connected and the second electrode group includes a plurality of second type of electrodes which are sequentially electrically connected, wherein, each of at least one type of electrodes of the first type of electrodes and the second type of electrodes includes a peripheral electrode arranged in the periphery and a central electrode electrically isolated from the peripheral electrode, and peripheral electrodes of two adjacent electrodes of the electrode group including the at least one type of electrodes are electrically connected to each other.

2. The capacitive touch screen of claim 1, wherein, each of the at least one type of electrodes is provided with a closed isolating trench, the central electrode is arranged at the inner side of the isolating trench, the peripheral electrode is arranged at the outer side of the isolating trench, and the peripheral electrode and the central electrode are isolated from each other by the isolating trench.

3. The capacitive touch screen of claim 2, wherein, the shape of the isolating trench is substantially the same as the contour shape of the electrode in which the isolating trench is located, and the depth of the isolating trench is equal to the thickness of the electrode.

4. The capacitive touch screen of claim 2, wherein, the first type of electrodes and the second type of electrodes are rhombus-shaped and are of the same size, the isolating trench is rhombus-shaped, and the width of the isolating trench is in the range of 5 μm to 30 μm.

5. The capacitive touch screen of claim 1, wherein, the area of each central electrode is 30% to 70% that of the electrode including the central electrode.

6. The capacitive touch screen of claim 4, wherein, a first type of conducting part is provided between rhombus corners of every two adjacent first type of electrodes along the direction the first electrode groups are arranged, and the two adjacent first type of electrodes are electrically connected to each other by the first type of conducting part; a second type of conducting part is provided between rhombus corners of every two adjacent second type of electrodes along the direction the second electrode groups are arranged, and the two adjacent second type of electrodes are electrically connected to each other by the second type of conducting part; the first type of conducting part and the second type of conducting part are provided in different layers and are partially overlapped in the orthogonal projection direction.

7. The capacitive touch screen of claim 6, wherein, an insulating layer is provided between the first type of conducting parts and the second type of conducting parts, one type of conducting parts of the first type of conducting parts and the second type of conducting parts are formed in the same layer as the first type of electrodes and the second type of electrodes, the other type of conducting parts of the first type of conducting parts and the second type of conducting parts are provided under the one type of conducting parts, the insulating layer is provided with via holes, and the other type of conducting parts and its corresponding electrodes are electrically connected to each other through the via holes respectively.

8. The capacitive touch screen of claim 6, wherein,
each of the first type of conducting parts is strip-shaped, the width of each of the first type of conducting parts is smaller than a space between two adjacent second type of electrodes along the direction the second electrode groups are arranged, and the length of each of the first type of conducting parts is equal to or larger than a space between two adjacent first type of electrodes along the direction the first electrode groups are arranged; and
each of the second type of conducting parts is strip-shaped, the width of each of the second type of conducting parts is smaller than the space between two adjacent first type of electrodes along the direction the first electrode groups are arranged, and the length of each of the second type of conducting parts is equal to or larger than the space between two adjacent second type of electrodes along the second electrode groups are arranged.

9. The capacitive touch screen of claim 7, wherein,
the first type of electrodes, the second type of electrodes and the one type of conducting parts which are provided in the same layer as the first and second type of electrodes are formed of Indium Tin Oxide; and
the other type of conducting parts which are provided in a layer different from that the first and second type of electrodes are provided in are formed of at least one from molybdenum, molybdenum-niobium alloy, aluminum, aluminum-neodymium alloy, titanium, and copper.

10. The capacitive touch screen of claim 1, wherein, a color filter layer is further provided on a surface of the substrate opposite to the first and second electrode groups.

11. A method for fabricating a capacitive touch screen including a step of forming a sensor electrode on a substrate, the sensor electrode includes a plurality of first electrode groups which are arranged in the row direction and parallel to each other, and a plurality of second electrode groups which are arranged in the column direction and parallel to each other; and the first electrode group includes a plurality of first type of electrodes which are sequentially electrically connected and the second electrode group includes a plurality of second type of electrodes which are sequentially electrically connected, wherein, each of at least one type of electrodes of the first type of electrodes and the second type of electrodes includes a peripheral electrode arranged in the periphery and a central electrode electrically isolated from the peripheral electrode, and peripheral electrodes of two adjacent electrodes of the electrode group including the at least one type of electrodes are electrically connected to each other.

12. The method of claim 11, wherein, the step of forming the sensor electrode on the substrate particularly includes:
Step S11: forming a pattern including one type of conducting parts of first type of conducting parts and second type of conducting parts on the substrate;
Step S12: forming an insulating layer on the substrate subjected to Step S11 such that the insulating layer is provided with via holes at regions corresponding to ends of the one type of conducting parts;
Step S13: forming patterns including the first type of electrodes, the second type of electrodes and the other type of conducting parts of the first type of conducting parts and the second type of conducting parts on the substrate subjected to Step S12 such that a pattern including a closed isolating trench is also formed in each of the at least one type of electrodes, and the central electrode and the peripheral electrode are electrically isolated from each other by the isolating trench; and
Step S14: forming a passivation layer on the substrate subjected to Step S13,
wherein,
when the one type of conducting parts are the first type of conducting parts, adjacent first type of electrodes are electrically connected to one of the first type of conducting parts through the via holes so as to be electrically connected to each other through one of first type of conducting parts, and adjacent second type of electrodes are electrically connected to each other through one of the second type of conducting parts; and
when the one type of conducting parts are the second type of conducting parts, adjacent first type of electrodes are electrically connected to each other through one of the first type of conducting parts, and adjacent second type of electrodes are electrically connected to one of second type of conducting parts through the via holes so as to be electrically connected to each other through one of second type of conducting parts.

13. The method of claim 12, wherein, in Step S13, forming the patterns including the first type of electrodes, the second type of electrodes and the other type of conducting parts which are provided in the same layer using one patterning process, the other type of conducting parts and the one type of conducting parts formed in Step S11 are partially overlapped in the orthogonal projection direction.

14. The method of claim 13, wherein, the shape of the isolating trench is substantially the same as the contour shape of the electrode in which the isolating trench is located, and the depth of the isolating trench is equal to the thickness of the electrode.

15. The method of claim 14, wherein, the first type of electrodes and the second type of electrodes are rhombus-shaped and are of the same size, the isolating trench is rhombus-shaped, and the width of the isolating trench is in the range of 5 μm to 30 μm.

16. The method of claim 15, wherein, the area of each central electrode is 30% to 70% that of the electrode including the central electrode.

17. The method of claim 15, wherein, each of the first type of conducting parts is strip-shaped, each of the first type of conducting parts is formed between rhombus corners of two adjacent first type of electrodes along the direction the first electrode groups are arranged respectively, the width of each of the first type of conducting parts is smaller than a space between two adjacent second type of electrodes along the direction the second electrode groups are arranged, and the length of each of the first type of conducting parts is equal to or larger than a space between two adjacent first type of electrodes along the direction the first electrode groups are arranged; and
each of the second type of conducting parts is strip-shaped, each of the second type of conducting parts is formed between rhombus corners of two adjacent second type of electrodes along the direction the second electrode groups are arranged respectively, the width of each of the second type of conducting parts is smaller than the space between two adjacent first type of electrodes along the direction the first electrode groups are arranged, and the length of each of the second type of conducting parts is equal to or larger than the space between two adjacent second type of electrodes along the second electrode groups are arranged.

18. The method of claim 17, wherein,
the first type of electrodes, the second type of electrodes and the other type of conducting parts which are provided in the same layer as the first and second type of electrodes are formed of Indium Tin Oxide; and
the one type of conducting parts which are provided in a layer different from that the first and second type of electrodes are provided in are formed of at least one from molybdenum, molybdenum-niobium alloy, aluminum, aluminum-neodymium alloy, titanium, and copper.

19. The method of claim 18, wherein,
after completing the step of forming the at least one type of electrodes such that each includes a peripheral electrode arranged in the periphery and a central electrode electrically isolated from the peripheral electrode and peripheral electrodes of two adjacent electrodes of the electrode group including the at least one type of electrodes are electrically connected to each other, the method further includes:
Step S21: inverting the substrate in the vertical direction; and
Step S22: forming a color filter film on the surface of the inverted substrate opposite to the first electrode group and the second electrode group.

20. The capacitive touch screen of claim 9, wherein, a color filter layer is further provided on a surface of the substrate opposite to the first and second electrode groups.
